(19) United States
(12) Patent Application Publication
(10) Pub. No.: US 2015/0004458 A1
(43) Pub. Date: Jan. 1, 2015

(54) BATTERY COOLING SYSTEM FOR VEHICLE

(71) Applicant: HYUNDAI MOTOR COMPANY, Seoul (KR)

(72) Inventor: Jung Soo Lee, Seoul (KR)

(73) Assignee: HYUNDAI MOTOR COMPANY, Seoul (KR)

(21) Appl. No.: 14/063,617

(22) Filed: Oct. 25, 2013

(30) Foreign Application Priority Data
Jun. 28, 2013 (KR) 10-2013-0075170

(51) Int. Cl. H01M 10/625

(52) U.S. Cl. CPC H01M 10/5016
USPC 429/120

(57) ABSTRACT

A battery cooling system for a vehicle is provided that includes a battery case installed on a roof or a floor of the vehicle, having an internal space formed in a length direction, including a blower disposed at one side of the internal space; a plurality of battery packs continuously installed in the battery case; and inner ducts provided in the plurality of battery packs, respectively, formed to enclose the respective battery packs in the battery case, and having a first plurality of apertures disposed at one end of the inner ducts so as to be in communication with outside of the battery case and a second plurality of apertures disposed at an opposite end of the inner ducts so as to be in communication with the inside of the battery case, the respective second apertures each having different outlet resistances.

### CROSS REFERENCE TO RELATED APPLICATION

This application claims under 35 U.S.C. §119(a) priority to Korean Patent Application No. 10-2013-0075170 filed on Jun. 28, 2013, the entire contents of which are incorporated herein by reference.

### BACKGROUND OF THE INVENTION

1. Technical Field

The present invention relates to a battery cooling system for a vehicle capable of efficiently cooling a battery pack of an electric vehicle or a hybrid vehicle.

2. Description of the Related Art

In accordance with popularization of the electric vehicle or the hybrid vehicle, the emphasis placed on battery performance has greatly increased as well. This emphasis focuses on the efficiency, lifespan, and the capacity of the battery, along with many other characteristics which effect the performance of the battery.

High voltage and high capacity batteries used in the electric vehicle or the hybrid vehicle generally includes a plurality of battery packs, each of which includes a plurality of battery cells. The plurality of battery packs are typically installed in a narrow space and therefore a significant amount of heat is generated in the battery packs in a small space, which negatively affects the lifespan of the entire battery. Therefore, it is necessary to construct a cooling system for controlling the heat in the high voltage and high capacity batteries used in the electric vehicle or the hybrid vehicle.

To this end, various battery pack cooling systems have been already devised. In related art, a cooling system includes a first group module and a second group module disposed in a row between an inlet and an outlet. The first group module in this system includes at least one battery module disposed to be relatively closer to the inlet and the second group module including at least one battery module disposed to be relatively close to the outlet. A first duct is disposed to allow air passing through the first group module while cooling the first group module from the inlet to bypass the second group module and be induced to the outlet. In addition, a second duct is disposed to allow the air bypassing the first group module from the inlet to pass through the second group module while cooling the second group module.

However, in the related art described above, the cooling efficiencies of the respective battery packs are different from each other. In addition, since air cooling one battery pack cools the next battery pack, a temperature deviation between the battery packs is quite large.

The matters described as the related art have been provided only for assisting in the understanding for the background of the present invention and should not be considered as corresponding to the related art known to those skilled in the art.

### SUMMARY OF THE INVENTION

An object of the present invention is to provide a battery cooling system for a vehicle that minimizes a temperature deviation between battery packs by individually providing ducts connected to the outside to the respective battery packs and allows outlet resistances of the respective ducts to be different from each other to allow cooling flow rates introduced into the respective battery packs to be the same for each battery pack.

According to an exemplary embodiment of the present invention, there is provided a battery cooling system for a vehicle. In particular, the battery cooling system includes a battery case installed at a roof or a floor of the vehicle. This battery case has an internal space formed in a length direction and includes therein a blower disposed at one side of the internal space which may discharge internal air of the battery case to the outside. A plurality of battery packs are consecutively installed in the battery case, and a plurality of inner ducts are provided within the plurality of battery packs, respectively, These inner ducts are formed to enclose the respective battery packs in the battery case, and have a first plurality of apertures disposed at one end of each inner duct so as to be in communication with the outside of the battery case and a second plurality of apertures disposed at an opposite end of each of the inner ducts so as to be in communication with an inside of the battery case. In particular, in order to achieve a consistent efficiency across all of the battery packs, the respective plurality of second apertures each have different outlet resistances. External air may be introduced into the battery packs through the first plurality of apertures, and the air introduced into the battery packs may be discharged into the battery case through the second plurality of apertures. As the inner ducts get closer to the blower, the outlet resistances may be increased.

The opposite end portions of the inner ducts may be configured to be bent so that the second plurality of apertures are directed in an upward direction, and edge portions of the second plurality of apertures may be configured to be bent toward the blower. Also, in some embodiments of the present invention, as the inner ducts get closer to the blower, the degree in which the edge portions of the second apertures are bent toward the blower may decrease.

### BRIEF DESCRIPTION OF THE DRAWINGS

FIG. 1 is a configuration diagram of a battery cooling system for a vehicle according to an exemplary embodiment of the present invention; and

FIG. 2 is a diagram showing the entire resistance curve of the system for an air flow rate of the battery cooling system for a vehicle according to the exemplary embodiment of the present invention.

### DESCRIPTION OF THE EXEMPLARY EMBODIMENTS

Hereinafter, a battery cooling system for a vehicle according to an exemplary embodiment of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion vehicles which include a high voltage or high capacity battery-back up, plug-in hybrid electric vehicles, hydrogen-powered vehicles, fuel cell vehicles, and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

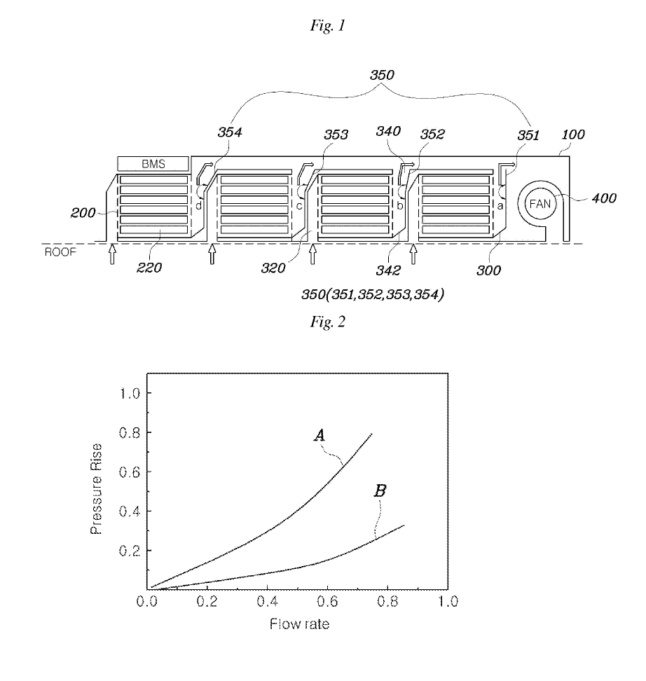

FIG. 1 is a configuration diagram of a battery cooling system for a vehicle according to an exemplary embodiment of the present invention. The battery cooling system for a vehicle is configured to include a battery case 100 installed at a roof or a floor of the vehicle. In particular, the battery case 100 has an internal space formed in a length direction and includes a blower 400 disposed at one side of the internal space. The blower may be configured to discharge internal air of the battery case 100 to the outside accordingly. A plurality of battery packs 200 are consecutively installed in the battery case 100, and inner ducts 300 are provided in the plurality of battery packs 200, respectively. The inner ducts 300 are formed to enclose the respective battery packs 200 in the battery case 100, and have a first plurality of apertures 320 disposed at one end of each of the inner ducts so as to be in communication with an environment surrounding an outside surface of the battery case 100 and a second plurality of apertures 340 disposed at an opposite end of each of the inner ducts so as to be in communication with an inside of the battery case 100. Particular, the respective second plurality of apertures 340 each have a different outlet resistance so that the efficiency is consistent through the battery packs.

In some exemplary embodiments, it is preferable that the battery case 100 is installed at, on, or within the roof or the floor of the vehicle. However, the battery case 100 is not limited to being installed at, in, on or within the roof or the floor of the vehicle, but may be installed at various positions such as a trunk, an engine room, or the like, of the vehicle.

As stated above, the battery case 100 includes a plurality of battery packs 200 consecutively installed therein. These battery packs 200 may be configured of a plurality of battery cells 220 each configured to be stacked. Here, it is preferable that the stacked battery cells 220 are not completely adhered to each other, but have a predetermined space formed therebetween so that external air may pass therebetween to maximize a cooling efficiency of the battery cells 220. It is preferable that the inner ducts 300 are configured so that the external air is introduced into the battery packs 200 through the first plurality of apertures 320 and the air introduced into the battery packs 200 is discharged into the battery case 100 through the second plurality of apertures 340.

More specifically, in order for the external air to be introduced into the battery packs 200 through the first plurality of apertures 320, the battery case 100 is provided with through-apertures (not shown) corresponding to the number of coinciding first apertures 320. As such, the first apertures 320 and the through-apertures are connected to each other, such that the external air may be introduced.

The external air introduced through the first aperture 320 cools the battery packs 200 positioned in the inner duct 300 while passing through the battery packs 200, and the air passing through the battery packs 200 moves to the second aperture 340 positioned in the battery case 100 and is then discharged to the outside through the blower 400.

Here, the second plurality of apertures 340 of the inner ducts 300 are formed to each have different outlet resistances. It is preferable that as the inner ducts 300 get closer to the blower 400, the outlet resistances is increased. The reason is that as the inner ducts 300 gets closer to the blower 400, an air resistance existing between the inner duct 300 and the blower 400 is decreased. Conversely, as the inner ducts 300 get further from the blower 400, the air resistance existing between the inner duct 300 and the blower 400 is increased, such that more air flows to a side having a less air resistance. When it is assumed that the outlet resistances of all of the inner ducts 300 are the same as each other, an increased air flow rate passes through the inner duct 300 positioned to be close to the blower 400. Since the entire air flow rate discharged through the blower 400 is fixed, an air flow rate passing through the inner duct 300 positioned to be further from the blower 400 is naturally decreased. This generates a difference in a cooling rate between the respective battery packs 200 to consequently cause a large temperature difference between the battery packs 200 that are closer to the blower 400 and the battery packs 200 that are further from the blower 400.

Therefore, as the inner ducts 300 get closer to the blower 400, the outlet resistances of the inner ducts 300 are stepwise increased so that the air flow rates flowing in the respective inner ducts 300 are equalized. Therefore, the cooling rates of all of the battery packs 200 are consistent, thereby making it possible to increase the entire cooling efficiency.

Various methods may be used in order to increase the outlet resistance of the inner duct 300. For example, installing a filter in the second aperture 340 and making the second aperture 340 narrow to increase a resistance may be used.

In addition, the opposite end portions 342 of the inner ducts 300 are bent so that the second apertures 340 are directed toward an upward direction, and edge portions 350 of the second apertures 340 are bent toward the blower 400, thereby making it possible to adjust the outlet resistance. When the inner ducts 300 have the above-mentioned shape, the outlet resistances of the respective inner ducts 300 may be easily changed without adding a separate device. That is, a degree in which the edge portions 350 of the second apertures 340 are bent is adjusted, thereby making it possible to change the outlet resistance. As the inner ducts 300 become closer to the blower 400, the degree in which the edge portions 350 of the second apertures 340 are bent toward the blower 400 becomes smaller.

More specifically, when it is assumed that the edge portion 350 of the second aperture 340 closest to the blower 400 is a first edge portion 351, the first edge portion 351 is formed so as not to substantially or completely form an angle (hereinafter, referred to as an angle a). Next, when it is assumed that the edge portion 350 of the second aperture 340 second closest to the blower 400 is a second edge portion 352, the second edge portion 352 is bent by a predetermined portion toward the blower 400 to form an angle (hereinafter, referred to as an angle b). When it is assumed that the edge portions 350 of the second apertures 340 are a third edge portion 353 and a fourth edge portion 354 according to a sequence in which they get further from the blower 400 and the respective angles are an angle c and an angle d, a degree in which the edge portions are bent is increased toward the fourth edge portion 354, that is, d>c>b>a, such that the outlet resistance at the fourth edge portion 354 may become smallest.

The reason why the outlet resistances of the respective inner ducts 300 may be adjusted by the above-mentioned method is that the entire air introduced from the outside and passing through the respective inner ducts 300 moves in the same direction, that is, toward the blower 400 and is that the introduced air may smoothly move toward the blower 400 only by adjusting the angles of the edge portions 350 of the second apertures 340. That is, if considering only resistances when the air passes through the edge portions 350, the air passing through the fourth edge portion 354 moves more easily, while being subjected to a less resistance, as compared with the air passing through the first edge portion 351.

In order to form outlet resistances through the method as described above, it is preferable that only some of the edge portions 350 of the inner ducts 300 are bent rather than bending all of the edge portions 350 of the inner ducts 300 in the same direction. In this case, it is preferable that the edge portions 350 directed toward the blower 400 are bent.

Alternatively, the opposite end portion 342 of the inner duct 300 is not formed of a pipe having a cylindrical shape or other specific shapes, but may be configured to form a channel only with half of the inner duct. In this case, it is preferable that a lower end portion of the inner duct 300 is used and an upper end portion thereof is open/exposed

In some exemplary embodiments of the present invention, some of the inner ducts 300 are bent to allow flow rates of the respective inner ducts 300 to operate smoothly and apply only some resistance to certain apertures, thereby making it possible to increase the entire air flow rate while allowing air flow rates of the respective inner ducts 300 to be same as each other.

With the battery cooling system for a vehicle having the structure as described above, the outlet resistances of the second plurality of apertures 340 are different from each other for each inner duct 300 to allow the cooling flow rates flowing in the respective inner ducts 300 to become equalized, such that the cooling efficiencies of the respective battery cells 220 are consistent, thereby making it possible to increase the cooling efficiency.

In addition, the inner ducts 300 are separately provided to the battery packs 200, respectively, so that the battery packs 200 may be individually cooled. Therefore, the number of battery packs 200 configuring the battery may be maximized.

In addition, since the respective inner ducts 300 are connected to the outside to introduce the air from the outside, a cooling flow rate of the blower 400 may be increased. Therefore, cooling flow rates passing through the respective battery packs 200 are also increased, such that the entire cooling efficiency may be increased.

In relation to this, FIG. 2 is a diagram showing the entire resistance curve of the system for an air flow rate of the battery cooling system for a vehicle according to the exemplary embodiment of the present invention. Here, the entire resistance of the system refers to a degree of resistance that should be overcome in order for the blower 400 to discharge all of the air in the battery case 100. In FIG. 2, an X axis indicates an air flow rate, and a Y axis indicates, a pressure, that is, the entire resistance degree of the system.

A curve A of FIG. 2 indicates the entire resistance curve of the system for an air flow rate according to the related art, and a curve B of FIG. 2 indicates the entire resistance curve of the system for an air flow rate according to the exemplary embodiment of the present invention. As definitely seen from FIG. 2, the entire system resistance is decreased to a half level and the air flow rate flowing in the battery case 100 is increased, through the present invention. That is, it may be seen that an effect of increasing the entire cooling efficiency has been generated.

With the battery cooling system for a vehicle having the structure as described above, the outlet resistances of the second plurality of apertures are different from each other for each inner duct to allow the cooling flow rates flowing in the respective inner ducts to become equalized, such that the cooling efficiencies of the respective battery cells are consistent, thereby making it possible to increase the cooling efficiency.

In addition, the inner ducts are separately provided to the battery packs, respectively, so that the battery packs may be individually cooled. Therefore, the number of battery packs configuring the battery may be maximized

In addition, since the respective inner ducts are connected to the outside to introduce the air from the outside, a cooling flow rate of the blower may be increased. Therefore, cooling flow rates passing through the respective battery packs are also increased, such that the entire cooling efficiency may be increased.

Although the present invention has been shown and described with respect to specific exemplary embodiments, it will be obvious to those skilled in the art that the present invention may be variously modified and altered without departing from the spirit and scope of the present invention as defined by the following claims.

What is claimed is:

1. A battery cooling system for a vehicle, comprising:
a battery case installed at a roof or a floor of the vehicle, the battery case having an internal space formed in a length direction, and includes a blower disposed at one side of the internal space;
a plurality of battery packs consecutively installed in the battery case; and
a plurality of inner ducts each provided in the plurality of battery packs, respectively, the plurality of inner ducts formed to enclose the respective battery packs in the battery case, and having a first plurality of apertures disposed at one end of the inner ducts so as to be in communication with outside of the battery case and a second plurality of apertures disposed at an opposite end of the inner ducts so as to be in communication with the inside of the battery case, the respective second apertures each having different outlet resistances.

2. The battery cooling system for a vehicle of claim 1, wherein the blower discharges internal air of the battery case to the outside.

3. The battery cooling system for a vehicle of claim 1, wherein external air is introduced into the battery packs through the first plurality of apertures, and the air introduced into the battery packs is discharged into the battery case through the second plurality of apertures.

4. The battery cooling system for a vehicle of claim 1, wherein as the inner ducts get closer to the blower, the outlet resistances increases.

5. The battery cooling system for a vehicle of claim 1, wherein the opposite ends of the inner ducts are configured to be bent so that the second plurality of apertures are directed in an upward direction, and edge portions of the second plurality of apertures are bent toward the blower.

6. The battery cooling system for a vehicle of claim 5, wherein as the inner ducts get closer to the blower, a degree in which the edge portions of the second plurality of apertures are bent toward the blower decreases.

7. A vehicle operable as hybrid vehicle, an electric vehicle or a fuel cell vehicle, the vehicle comprising:
a battery case installed within the vehicle, and including a blower disposed at one side of an internal space in the battery case;
a plurality of battery packs consecutively installed in the battery case; and
a plurality of inner ducts each provided in the plurality of battery packs, respectively, the plurality of inner ducts formed to enclose the respective battery packs in the battery case,
wherein the plurality of inner ducts include a first plurality of apertures disposed at one end of the inner ducts so as to be in communication with outside of the battery case and a second plurality of apertures disposed at an opposite end of the inner ducts so as to be in communication with the inside of the battery case, the respective second plurality of apertures each having different outlet resistances.

8. The vehicle of claim 7, wherein the blower discharges internal air of the battery case to the outside.

9. The vehicle of claim 7, wherein external air is introduced into the battery packs through the first plurality of apertures, and the air introduced into the battery packs is discharged into the battery case through the second plurality of apertures.

10. The vehicle of claim 7, wherein as the inner ducts get closer to the blower, the outlet resistances increases.

11. The vehicle of claim 7, wherein the opposite ends of the inner ducts are configured to be bent so that the second plurality of apertures are directed in an upward direction, and edge portions of the second plurality of apertures are bent toward the blower.

12. The vehicle of claim 11, wherein as the inner ducts get closer to the blower, a degree in which the edge portions of the second plurality of apertures are bent toward the blower decreases.
